(19) United States
(12) Patent Application Publication
(10) Pub. No.: US 2013/0164098 A1
(43) Pub. Date: Jun. 27, 2013

(54) MOUNTING DEVICE

(71) Applicants: HONG FU JIN PRECISION INDUSTRY, Shenzhen City (CN); HON HAI PRECISION INDUSTRY CO., LTD., Tu-Cheng (TW)

(72) Inventor: HAO CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/626,980

(22) Filed: Sep. 26, 2012

(30) Foreign Application Priority Data
Dec. 26, 2011 (CN) 201110440911.2

(51) Int. Cl. F16B 35/04

(52) U.S. Cl. 411/424

(57) ABSTRACT

A mounting device includes a mounting piece and a mounting member. The mounting piece defines a stepped hole and includes a top surface, a bottom surface, and a blocking ring in the stepped hole. The mounting member is rotatably mounted in the stepped hole and includes a threaded portion. The blocking ring is between the top surface and the bottom surface. When the mounting member is moved towards the bottom surface, the threaded portion extends out of the bottom surface and locks into an object to secure the mounting piece to the object. When the mounting member is moved towards the top surface, the threaded portion is retracted back to the stepped hole, and the blocking ring prevents the mounting member from moving out of the mounting piece.

### BACKGROUND

1. Technical Field

The present disclosure relates to mounting devices, and particularly to a mounting device for securing a first object to a second object.

2. Description of Related Art

Often, screws are used to secure two or more objects together. Due to relatively small sizes of the screws, compared to the objects secure together by the screws, and the need to manually manipulate the screws to extend through holes in the objects, the use of screws is labor intensive. In addition, the screws can be easily dropped and lost.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting device.

FIG. 2 is an assembled, isometric view of the mounting device of FIG. 1.

FIG. 3 is a cross-sectional view of the electronic device of FIG. 2 taken along a line III-III, and a mounting member is in a first position.

FIG. 4 is similar to FIG. 3, but the mounting member is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

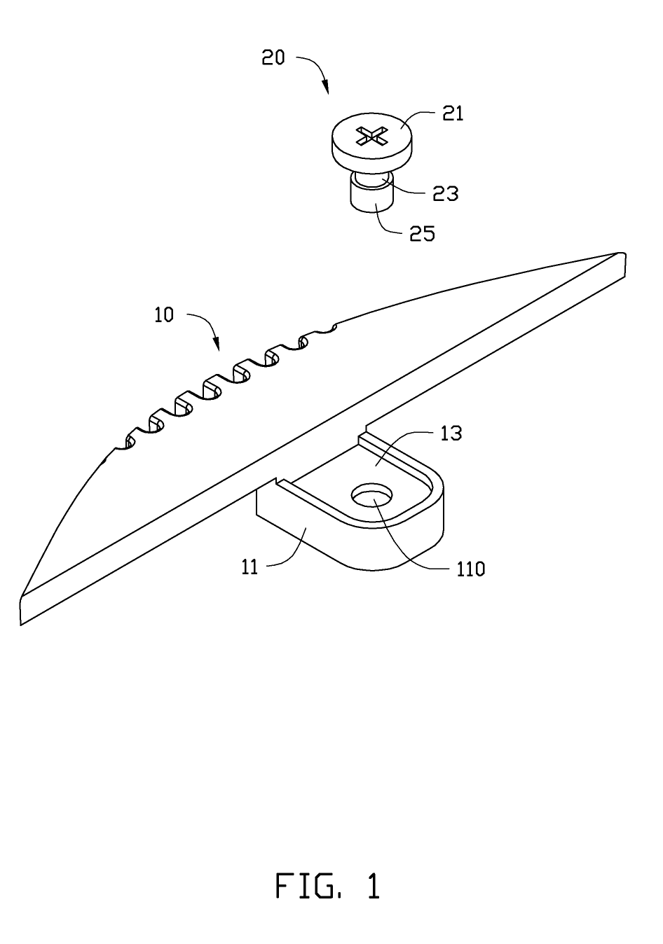

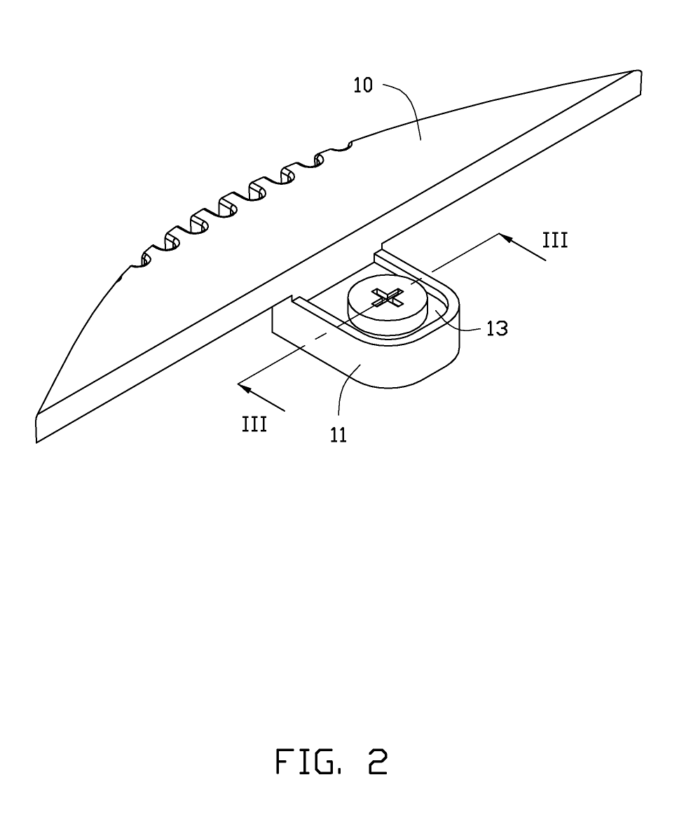

Referring to FIGS. 1-3, a mounting device in accordance with an embodiment is shown. The mounting device comprises an object 10 and a mounting member 20.

The object 10 comprises a mounting piece 11. The mounting piece 11 comprises a top surface 13 and a bottom surface 15 substantially parallel to the top surface 13. The mounting piece 11 defines a stepped hole 110. The stepped hole 110 comprises a first mounting hole 111 and a second mounting hole 112 communicating with the first mounting hole 111. The first mounting hole 111 and the second mounting hole 112 extend from the top surface 13 to the bottom surface 15. In one embodiment, the first mounting hole 111 and the second mounting hole 112 are circular. A diameter of the first mounting hole 111 is smaller than a diameter of the second mounting hole 112, so as to form a blocking ring 16 between the first mounting hole 111 and the second mounting hole 112. In one embodiment, the mounting piece 11 is made of plastic, and the blocking ring 16 is substantially parallel to the top surface 13 and the bottom surface 15.

The mounting member 20 comprises a blocking portion 21, a connecting portion 23, and a threaded portion 25. In one embodiment, a cross-section of each of the blocking portion 21, the connecting portion 23, and the threaded portion 25 is circular. The connecting portion 23 is secured between the blocking portion 21 and the threaded portion 25. A diameter of the connecting portion 23 is smaller than a diameter of the blocking portion 21 and the threaded portion 25, and the diameter of the threaded portion 25 is smaller than the diameter of the blocking portion 21. The threaded portion 25 comprises a plurality of external threads (not shown).

The mounting member 20 can be engaged in the first mounting hole 111 and the second mounting hole 112. The diameter of the threaded portion 25 is slightly greater than that of the first mounting hole 111 and smaller than that of the second mounting hole 12. The diameter of the blocking portion 21 is greater than that of the second mounting hole 112. The diameter of the connecting portion 23 is smaller than that of the first mounting hole 111.

In assembly, the threaded portion 25 of the mounting member 20 is aligned with the first mounting hole 111. The mounting member 20 is pressed towards the bottom surface 15. Because the diameter of the threaded portion 25 is slightly greater than the diameter of the first mounting hole, the threaded portion 25 causes a slight elastic expansion of the first mounting hole 111 and the threaded portion 25 is inserted into the first mounting hole 111. After the threaded portion 25 has gone through the first mounting hole 111, the inner surface of the first mounting hole 111 restores, and the threaded portion 25 is rotatably engaged in the second mounting hole 112. The blocking ring 16 prevents the threaded portion 25 from rising again towards the top surface 13.

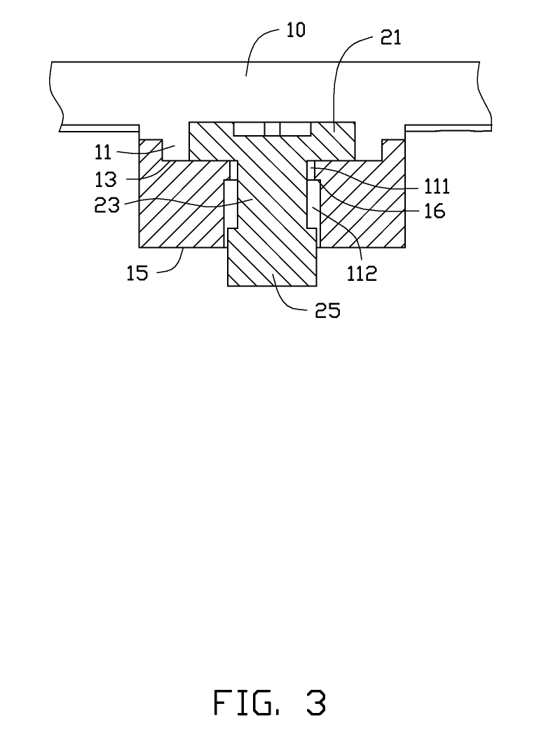

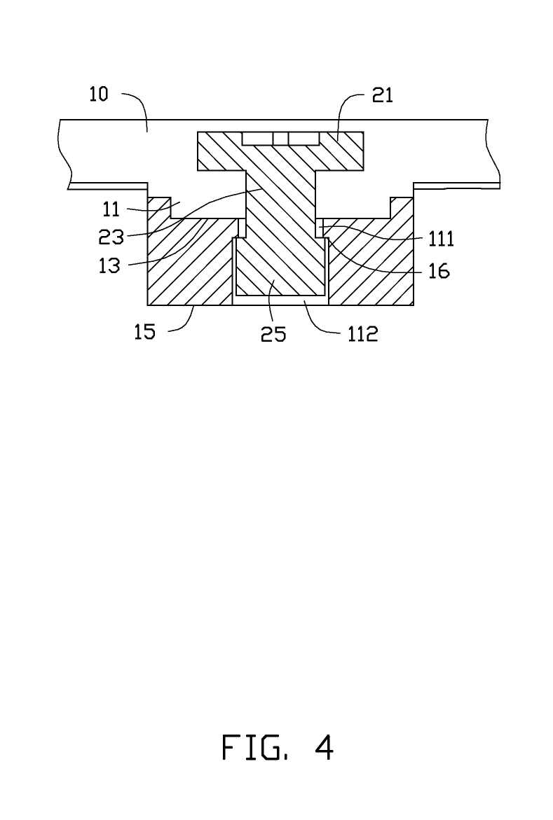

FIG. 3 and FIG. 4 show the mounting member 20 as movable in relation to the mounting piece 11, between a first position and a second position. Referring to FIG. 3, when the mounting member 20 is in the first position, the blocking portion 21 abuts the top surface 13. The threaded portion 25 extends out of the bottom surface 15. In this position, the threaded portion 25 can be locked into other object, to secure the object 10 to the other object. Referring to FIG. 4, when the mounting member 20 is in the second position, the threaded portion 25 is received in the second mounting hole, and the blocking ring 16 blocks the threaded portion 25 to prevent the mounting member 20 from being moved out of the first mounting hole 111.

When the mounting member 20 is to secure the object 10 to other object, the mounting member 20 is moved from the second position to the first position, and the threaded portion 25 is screwed into other object. When disassembly of the object 10 from other object is required, the mounting member 20 is moved from the first position to the second position. When the mounting member 20 is moved from the first position to the second position, the blocking ring 16 blocks the threaded portion 25 to prevent the mounting member 20 from dropping out of the mounting piece 11.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A mounting device, comprising:
a mounting piece defining a stepped hole and comprising a top surface, a bottom surface opposite to the top surface, and a blocking ring in the stepped hole; and
a mounting member movably mounted in the stepped hole and comprising a threaded portion;
wherein the blocking ring is between the top surface and the bottom surface; the mounting member is movable relative to the mounting piece; when the mounting member is moved from the top surface towards the bottom surface, the threaded portion extends out of the bottom surface and locks into an object to secure the mounting piece to the object; when the mounting member is moved from the bottom surface towards the top surface, the threaded portion is retracted back to the stepped hole, and the blocking ring abuts the threaded portion to prevent the mounting member from moving out of the mounting piece.

2. The mounting device of claim 1, wherein the stepped hole comprises a first mounting hole and a second mounting hole communicating with the first mounting hole; each of the first mounting hole and the second mounting hole is circular, and a diameter of the second mounting hole is greater than a diameter of the first mounting hole.

3. The mounting device of claim 2, wherein a cross-section of each of the threaded portion is circular, a diameter of the threaded portion is slightly greater than the diameter of the first mounting hole, but smaller than the diameter of the second mounting hole.

4. The mounting device of claim 3, wherein the mounting member further comprises a blocking portion and a connecting portion, the connecting portion is located between the blocking portion and the threaded portion, and the connecting portion is received in the stepped hole.

5. The mounting device of claim 4, wherein a cross-section of the connecting portion is circular, and a diameter of the connecting portion is smaller than the diameter of the threaded portion and the diameter of the first mounting hole.

6. The mounting device of claim 4, wherein the blocking portion is above the stepped hole; a cross-section of the blocking portion is circular, and a diameter of the blocking portion is greater than the diameter of the first mounting hole.

7. The mounting device of claim 1, wherein the blocking ring is substantially parallel to the top surface and the bottom surface.

8. The mounting device of claim 1, wherein the stepped hole extends through the mounting piece.

9. A mounting device, comprising:
a mounting piece defining a stepped hole and comprising a top surface, a bottom surface opposite to the top surface, and a blocking ring in the stepped hole; and
a mounting member movably mounted in the stepped hole and comprising a blocking portion and a threaded portion connected to the blocking portion;
wherein the blocking ring is between the top surface and the bottom surface; the mounting member is movable relative to the mounting piece between a first position and a second position; when the mounting member is in the first position, the threaded portion extends out of the stepped hole, and the blocking portion abuts the top surface to prevent the mounting member from moving towards the bottom surface; when the mounting member is in the second position, the threaded portion is retracted back to the stepped hole, and the blocking ring abuts the threaded portion to prevent the mounting member from moving towards the top surface.

10. The mounting device of claim 9, wherein the stepped hole comprises a first mounting hole and a second mounting hole communicating with the first mounting hole; each of the first mounting hole and the second mounting hole is circular, and a diameter of the second mounting hole is greater than a diameter of the first mounting hole.

11. The mounting device of claim 10, wherein a cross-section of each of the threaded portion and the blocking portion is circular, a diameter of the threaded portion is slight greater than the diameter of the first mounting hole, but smaller than the diameter of the second mounting hole.

12. The mounting device of claim 11, wherein the blocking portion is above the stepped hole, and the diameter of the blocking portion is greater than the diameter of the first mounting hole.

13. The mounting device of claim 11, wherein the mounting member further comprises a connecting portion between the blocking portion and the threaded portion, and the connecting portion is received in the stepped hole.

14. The mounting device of claim 13, wherein a cross-section of the connecting portion is circular, and a diameter of the connecting portion is smaller than the diameter of the threaded portion and the diameter of the first mounting hole.

15. The mounting device of claim 9, wherein the blocking ring is substantially parallel to the top surface and the bottom surface.

16. The mounting device of claim 9, wherein the stepped hole extends through the mounting piece.
